(19) United States
(12) Patent Application Publication
(10) Pub. No.: US 2026/0333122 A1
(43) Pub. Date: Oct. 22, 2026

(54) DYNAMIC ACCESS TRAFFIC STEERING, SWITCHING, AND SPLITTING SYSTEMS AND METHODS FOR A TELECOMMUNICATION NETWORK

(71) Applicant: CABLE TELEVISION LABORATORIES, INC., Louisville, CO (US)

(72) Inventors: Omkar Shripad Dharmadhikari, Denver, CO (US); Jason W. Rupe, Lafayette, CO (US)

(21) Appl. No.: 19/651,286

(22) Filed: Apr. 17, 2026

Related U.S. Application Data
(60) Provisional application No. 63/796,482, filed on Apr. 29, 2025.
(60) Provisional application No. 63/790,677, filed on Apr. 17, 2025.

(51) Int. Cl. H04W 28/02; H04L 41/16

(52) U.S. Cl. CPC H04W 28/0289; H04L 41/16

(57) ABSTRACT

Dynamic and real-time access traffic steering, switching, and splitting (ATSSS) systems and methods for a telecommunication network are provided. An ATSSS engine of the telecommunication network receives and inputs into a machine learning model (MLM): user equipment (UE) performance data from a UE and network performance data from a network module. The MLM is configured to: generate a prediction comprising a predicted network performance and a predicted UE performance based on the UE performance data and the network performance data; and generate an adjustment to a traffic parameter based on the prediction to yield an adjusted traffic parameter. The adjusted traffic parameter is transmitted to a policy manager configured to update one or more policies based on the adjusted traffic parameter to yield one or more updated policies.

### CROSS REFERENCE TO RELATED APPLICATIONS

This application claims the benefit of and priority to U.S. Provisional Application No. 63/790,677, filed on Apr.17, 2025 and U.S. Provisional Application No. 63/796,482, filed on Apr. 29, 2025, which is incorporated herein by reference in its entirety.

### BACKGROUND

The field of the disclosure relates generally to access traffic steering, switching, and splitting (ATSSS), and more particularly, to dynamic ATSSS systems and methods for a telecommunication network.

Modern telecommunication systems are increasingly relying on multiple access technologies to provide continuous and reliable connectivity. Although devices may be capable of connecting through various wired and wireless access networks, conventional mechanisms for managing these connections are static and unable to adapt to rapidly changing network conditions. Such conventional mechanisms steer, switch, or split traffic based on predetermined rules, but these rules do not account for dynamic factors such as real-time network load, congestion trends, device conditions, link conditions, stability, use case needs (latency, data loss, etc.), net utility, power conservation, planned/unplanned maintenance, repair, mobility patterns, or context changes. As a result, traffic may be routed over suboptimal links, leading to decreased performance, user dissatisfaction, and inefficient utilization of available network resources.

Additionally, conventional multi-access systems typically cannot diagnose or prevent connectivity issues. When performance degradation occurs, the system typically lacks access to telemetry from multiple network paths, making it difficult to determine whether the root cause is congestion, link failure, environmental disruption, or device-specific limitations. This inability to proactively detect emerging issues or automatically refine traffic policies impedes timely corrective action and often requires manual intervention. Further, when a hard failure occurs, a network end may not be accessible, including its telemetry and logs, which may aid in localization, remediation, and reduced repair time.

Thus, a technical problem exists in that conventional frameworks for telecommunication systems are not designed to provide adaptive and dynamic policy refinement in response to decreasing network or device performance and are not designed to diagnose connectivity issues in the systems and/or use telemetry to determine an appropriate ATSSS response.

### SUMMARY

Dynamic and adaptive ATSSS systems and methods and network impairment detection and diagnosis in such systems are provided. The ATSSS systems and methods dynamically adjust network policies in real-time based on predicted network performance and conditions, as well as expected user equipment performance needs. The ATSSS systems and methods are also enabled to detect network impairments and automatically execute a troubleshooting process. Thus, the dynamic and adaptive ATSSS systems can beneficially direct traffic flows to adapt to changing network conditions or detected impairments, and to optimize for the user equipment needs to improve a user experience.

A method of dynamic and real-time access traffic steering, switching, and splitting (ATSSS) for a telecommunication network according to at least one embodiment of the present disclosure comprises receiving, by an ATSSS engine of the telecommunication network: user equipment (UE) performance data from a UE, network performance data from a network module; inputting, by the ATSSS engine, the UE performance data and the network performance data into a machine learning model (MLM), the MLM configured to: generate a prediction comprising a predicted network performance and a predicted UE performance based on the UE performance data and the network performance data; generate an adjustment to at least one traffic parameter based on the prediction to yield at least one adjusted traffic parameter; receiving, by the ATSSS engine, the at least one adjusted traffic parameter as output from the MLM; and transmitting, by the ATSSS engine, the at least one adjusted traffic parameter to a policy manager configured to update one or more policies based on the at least one adjusted traffic parameter to yield one or more updated policies.

Any of the aspects herein, wherein the at least one traffic parameter comprising a steering parameter, a switching parameter, and a splitting parameter.

Any of the aspects herein, wherein the policy manager is further configured to apply the one or more updated policies to one or more network functions.

Any of the aspects herein, wherein the one or more network functions comprises an access and mobility management function (AMF) and a session management function (SMF).

Any of the aspects herein, wherein the ATSSS engine further receives user input data from a user interface and environmental data from an environmental module, and wherein the prediction is further based on the user input data and the environmental data.

Any of the aspects herein, wherein the adjusting is configured to optimize the UE performance data.

Any of the aspects herein, wherein the MLM uses reinforcement learning (RL) and is trained using historical data as training data.

Any of the aspects herein, wherein the MLM is fine‑tuned using real-time data.

Any of the aspects herein, wherein the network performance data is generated from network sensor data received and processed by the network module from a network sensor.

Any of the aspects herein, wherein the UE performance data is generated from UE sensor data received from a UE sensor.

Any of the aspects herein, wherein the UE sensor data is processed by at least one of a UE management application of the UE to yield UE state change data, and wherein the UE management application transmits the UE state change data to a core management application when a change in a UE state is detected.

Any of the aspects herein, wherein the core management application receives the UE state change data, executes a troubleshooting process to determine a potential impairment based on the UE state change data, and outputs at least one troubleshooting notification.

Any of the aspects herein, wherein the troubleshooting notification includes at least one troubleshooting instruction.

Any of the aspects herein, wherein the troubleshooting process is executed by the MLM.

A method of detecting an impairment in an access traffic steering, switching, and splitting (ATSSS)-enabled telecommunication network according to at least one embodiment of the present disclosure comprises receiving, by an ATSSS engine of the telecommunication network, user equipment (UE) state change data from a UE management application, the UE state change data generated from the UE management application processing UE sensor data received from a UE sensor; and inputting, by the ATSSS engine, the UE state change data into a core management application, the core management application configured to: execute a troubleshooting process to determine a potential impairment based on the UE state change data, and generate a troubleshooting notification based on the potential impairment.

Any of the aspects herein, further comprising: detecting, by an edge management application of an edge device, a trigger in network edge performance data from an edge sensor; executing, by the edge management application, one or more ATSSS procedures based on the trigger; transmitting, by the edge management application, edge state change data; inputting, by the ATSSS engine, the edge state change data into the core management application, the core management application further configured to: execute the troubleshooting process to determine an impairment causing the trigger, and generate a troubleshooting notification based on the impairment.

Any of the aspects herein, wherein the ATSSS procedures are generated by the core management application.

Any of the aspects herein, wherein the UE state change data includes UE status change data.

Any of the aspects herein, wherein the edge state change data includes edge status change data.

A dynamic spectrum allocation system for a telecommunication network according to at least one embodiment of the present disclosure comprises a user equipment (UE) comprising at least one UE sensor, the UE configured to generate UE performance data from UE sensor data received from the at least one UE sensor; a network module comprising at least one network sensor, the network module configured to generate network performance data from network sensor data received from the at least one network sensor; a machine learning model (MLM) configured to: generate a prediction comprising a predicted future network performance and a predicted UE performance based on the UE performance data and the network performance data received as input; and generate an adjustment to at least one traffic parameter based on the prediction to yield at least one adjusted traffic parameter, the at least one traffic parameter comprising a steering parameter, a switching parameter, and a splitting parameter; and a policy manager configured to update one or more policies based on the at least one adjusted traffic parameter to yield one or more updated policies.

The details of one or more aspects of the disclosure are set forth in the accompanying drawings and the description below. Other features, objects, and advantages of the techniques described in this disclosure will be apparent from the description and drawings, and from the claims.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present invention will become apparent to those skilled in the art upon consideration of the embodiment descriptions provided hereinbelow.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a block diagram of a dynamic access traffic steering, switching, and splitting (ATSSS) system for a telecommunication network according to at least one embodiment of the present disclosure;

FIG. 2 is a dataflow of an ATSSS system for a telecommunication network according to at least one embodiment of the present disclosure;

FIG. 3 is another dataflow of an ATSSS system according to at least one embodiment of the present disclosure;

FIG. 4 is a flowchart according to at least one embodiment of the present disclosure;

FIG. 5 is a flowchart according to at least one embodiment of the present disclosure;

FIG. 6A shows an example of a computing system, in accordance with one or more embodiments; and

FIG. 6B shows an example of a network, in accordance with one or more embodiments.

### DETAILED DESCRIPTION

### I.Definitions

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (i.e., X₁ and X₂) as well as a combination of elements selected from two or more classes (i.e., Y₁ and Zₒ).

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

As used herein, the term “database” may refer to either a body of data, a relational database management system (RDBMS), or to both, and may include a collection of data including hierarchical databases, relational databases, flat file databases, object-relational databases, object-oriented databases, and/or another structured collection of records or data that is stored in a computer system.

As used herein, the terms “processor” and “computer” and related terms, i.e., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc – read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include computer program storage in memory for execution by personal computers, workstations, clients, and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the term “telecommunication network” or refers to a system of interconnected devices connected by links (e.g., cable, fiber, wireless, etc.) over which data can be transmitted between the interconnected devices. The telecommunication network can include, for example, cable networks, hybrid fiber-coaxial networks, fiber networks, a radio frequency network, any wired network, any wireless network, or any hybrid network.

The person of ordinary skill in the art will understand that the term “wireless,” as used herein in the context of optical transmission and communications, including free space optics (FSO), generally refers to the absence of a substantially physical transport medium, such as a wired transport, a coaxial cable, or an optical fiber or fiber optic cable.

As used herein, the term “data center” generally refers to a facility or dedicated physical location used for housing electronic equipment and/or computer systems and associated components, i.e., for communications, data storage, etc. A data center may include numerous redundant or backup components within the infrastructure thereof to provide power, communication, control, and/or security to the multiple components and/or subsystems contained therein. A physical data center may be located within a single housing facility, or may be distributed among a plurality of co-located or interconnected facilities. A ‘virtual data center’ is a non-tangible abstraction of a physical data center in a software-defined environment, such as software-defined networking (SDN) or software-defined storage (SDS), typically operated using at least one physical server utilizing a hypervisor. A data center may include as many as thousands of physical servers connected by a high-speed network.

The term “access network” generally refers to a network or network segment configured to provide connectivity and access‑level communication services between user equipment(s) (UE) and a core network or other downstream network infrastructure. The access network enables the transmission of user data, control signaling, or both between the UE and the core network or other network infrastructure.

The term “access traffic steering, switching, and splitting” (ATSSS) generally refers to managing how data traffic is conveyed over available access networks. Traffic steering refers to selecting and directing traffic to a particular access path or access network from multiple options. Traffic switching refers to transferring traffic from one access path or access network to another by discontinuing use of a first access and initiating use of a different access. Traffic splitting refers to simultaneously distributing traffic across two or more access paths or access networks, with different portions of the traffic transmitted in parallel.

The term “network function” generally refers to a defined logical operation or capability performed by a network component to support communication, control, management, or service delivery within a telecommunication network. A network function may process signaling, user data, or control information and may be implemented in hardware, software, or a combination thereof. Functions may operate independently or in coordination with other functions and may be realized as physical network elements or virtualized, software-based components.

The term “policy” generally refers to a rule or set of rules that governs the behavior, operation, or decision-making of network functions with respect to access, mobility, security, quality of service, resource usage, or service delivery. A policy may specify conditions, constraints, priorities, or actions to be applied to traffic, devices, users, or network resources within a telecommunication network.

The term “application” generally refers to software or a set of executable instructions configured to perform specific functions or services when executed by a computing system. An application may operate on a user device, network device, server, or distributed computing platform, and may interact with hardware or other software components. An application may generate, process, transmit, receive, or manage data and may be executed with or without direct user interaction.

As used herein, an “agent” generally refers to a computer implemented software component that interfaces or includes a language model and autonomously generates, selects, and executes one or more actions based on language model outputs, system state, and objective criteria, without requiring continuous human control. The agent may be configured to ingest inputs, consult with the language model, select and execute actions, and maintain state information. The agent may further be configured to evaluate outcomes and update itself in a feedback mechanism.

The term “sensor” generally refers to components configured to detect, measure, or monitor physical, environmental, or operational conditions and to generate corresponding signals or data. Sensors may be implemented as standalone hardware, integrated within other devices, or combined with processing circuitry, and may provide analog or digital outputs for use by a computing system, network device, or application.

The term “Artificial Intelligence” or “AI” refers to one or more computer‑implemented systems, models, engines, or processes configured to perform tasks that include, but are not limited to, learning from data, identifying patterns, reasoning, predicting outcomes, classifying information, generating outputs, making decisions, or adapting behavior based on experience or inputs, using deterministic or probabilistic techniques. AI includes, for example, software and/or hardware systems that employ mathematical models, algorithms, heuristics, statistical methods, machine learning techniques, neural networks, rule-based logic, optimization routines, or combinations thereof, to process data and produce outputs. AI also includes machine learning models (MLM) capable of training, retraining, inference, or execution, including supervised, unsupervised, semi-supervised, reinforcement, or hybrid learning techniques, as well as non-learning computational approaches, to generate, for example, predictions, recommendations, classifications, or control signals.

### II.Example Dynamic ATSSS System

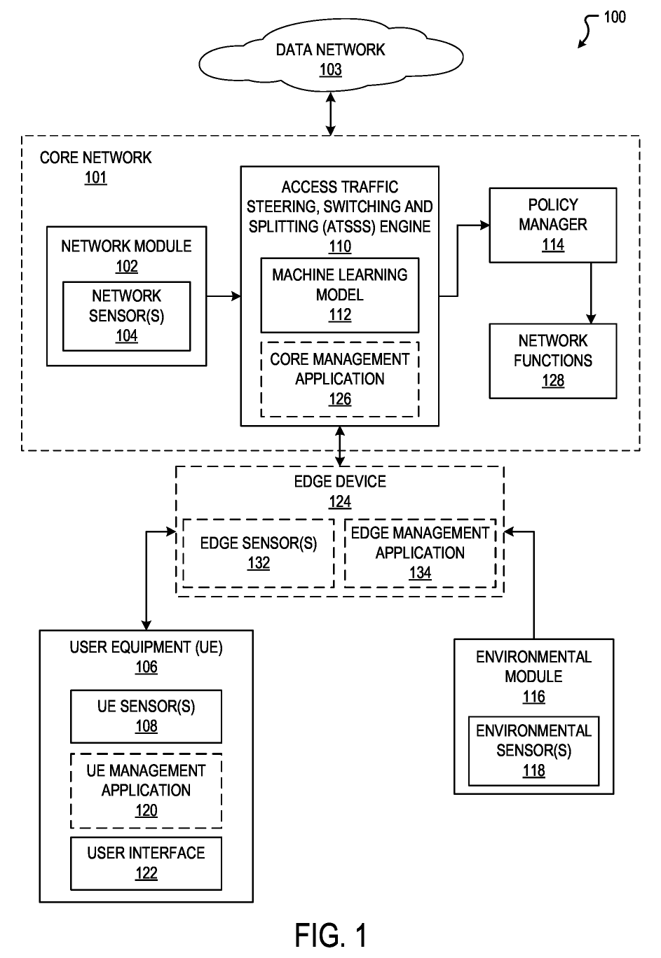

Turning to the Figures, FIG. 1 is a block diagram of a dynamic ATSSS system (100) (also referred to as “the system (100)”), according to at least one embodiment of the present disclosure. The system (100) can be implemented in any telecommunication network. Further, any of the components of the system (100) described below are ATSSS-enabled or can enable other components to execute ATSSS.

Generally, the system (100) uses artificial intelligence (AI) to conduct dynamic ATSSS in real-time to optimize network traffic and prevent or mitigate anticipated issues based on predicted future network conditions. More specifically, the system (100) uses AI or machine learning models (MLM) to predict future network performance and future user equipment (UE) performance, determines adjustments to traffic parameters such as steering parameters, switching parameters, and/or splitting parameters, and automatically updates network policies to adjust network traffic accordingly.

Alternatively, or additionally, the system (100) may also be used to detect a state change at the UE and/or at an edge device, which may indicate an impairment or connectivity issue at or near the UE and/or the edge device or within the telecommunication network. The system (100) may be used to automatically run a troubleshooting protocol and provide a troubleshooting notification and/or instructions. Further, the edge device may conduct ATSSS to mitigate the impairment until troubleshooting and repair is/are complete.

As shown, the system (100) includes a data network (103), a core network (101), UE(s) (106), an edge device (124), and an environmental module (116). The data network (103) provides data transport between network entities or components. The data network (103) can be, for example, a personal area network (PAN), a local area network (LAN), a wide area network (WAN), a metropolitan area network (MAN), a satellite network, a cellular network, etc.

The core network (101) is a centralized or logically centralized network architecture having multiple network components that provide control, management, authentication, routing, switching, security, and service enablement functions. More specifically, the core network (101) is configured to establish and manage a communication session for the UE (106) and routes data from the UE (106) to the data network (103) and vice versa. The core network (101) can be, for example, a cellular core network (e.g., 4G, 5GC), a private core network, an internet service provider core network, an Internet of Things (IoT) core network, etc. In some embodiments, an access network can connect to the core network (101) at multiple points.

The UE (106) is an electronic device or combination of devices configured to generate and receive data. The UE (106) can exchange data with the core network (101), which as described about, can route the data to the data network (103) and receive and route responses from the data network (103) to the UE (106). In other words, the UE (106) can access the data network (103) indirectly via the core network (101). The UE (106) can be, for example, a computing device, a smart watch, a cellular device, or any other device capable of connecting to a telecommunication network.

The UE (106) includes UE sensors (108). The UE sensors (108) are configured to sense, collect, and/or measure sensor data correlating to UE data such as, for example, a location of the UE in the network, UE mobility, power usage, and/or a battery level of the UE, etc. The UE sensors (108) can include any number of UE sensors such as one UE sensor, two UE sensors, or more than two UE sensors.

The UE (106) also includes a user interface (122). The user interface (122) is configured to receive user input from a user and/or present information to a user. The user input may include user preferences such as, for example, types of data to prioritize (e.g., prioritize streaming video data), power usage profiles (e.g., battery saver or high performance), specific traffic requirements (e.g., latency-sensitive traffic, high throughput traffic, mission critical traffic, security sensitive traffic, priority traffic, gaming traffic, critical-app based traffic (zoom call)), etc. The UE data and/or the user input can also be processed to generate other UE data such as, for example, UE mobility, UE usage patterns, US application types, specific traffic requirements (e.g., latency-sensitive traffic, high throughput traffic, mission critical traffic, security sensitive traffic, priority traffic, gaming traffic, critical-app based traffic (teleconference call)), etc.

The UE (106) can also include a UE management application (120). In some embodiments, the UE (106) may not include the UE management application (120). The UE management application (120) may be configured to process the UE sensor data to detect a change in the UE’s (106) status and/or state, which may indicate an impairment in the UE’s (106) connection. The UE management application (120) is also configured to conduct ATSSS on the UE (106). The UE management application (120) may exist centrally in the UE (106), may be distributed, may exist externally at a sensor or and interfacing module, or in other forms. The UE management application (120) may also receive and process data from other sensors or network devices.

For example, the UE (106) may attempt to switch networks when the UE (106) is moved further away from one network and closer to another network. However, the UE (106) may be unable to switch networks due to an impairment in the connection and a decrease in connection quality may be detected and indicate an impairment. In another example, the UE (106) may be in a location where the UE (106) should be load sharing; however, the UE’s (106) status may be non-load sharing, which may indicate an impairment.

The UE management application (120) is also configured to transmit UE state change data to a core management application (126) in the core network (101). The UE state change data may, for example, include status change data, a location of the UE (106), signal strength, and/or logged event data, for example. The UE management application (120) can also coordinate with the edge device (124) or other network devices or sensors to gather, process, and/or transmit data to the core network (101).

The system (100) also includes the edge device (124). In some embodiments, the system (100) does not include the edge device (124). In such embodiments, the UE (106) may communicate with the core network (101) solely through an access network (not shown). In other embodiments, the edge device (124) may be part of or otherwise associated with an access network.

The edge device (124) may include hardware, software, firmware, or any combination thereof, and may be implemented as a physical device or a virtualized component. The edge device (124) is deployed at or near an edge of a telecommunication network and configured to perform processing, control, storage, aggregation, routing, or intermediary functions between the UE (106) (and/or the environmental module (116)) and the core network (101). Such functions of the edge device (124) may be distributed in some embodiments, or central in other embodiments.

The edge device (124) includes edge sensors (132), which are configured to sense, collect, and/or measure sensor data correlating to edge data such as, for example, a location of the edge device in the network, power usage, and/or a battery level of the edge device, network traffic, connection data, etc. The edge sensors (132) can include any number of edge sensors such as one edge sensor, two edge sensors, or more than two edge sensors. The edge sensors (132) may have distinct, partially overlapping, or the same function with the same or different scopes.

The edge device (124) can also include an edge management application (134). In some embodiments, the edge device (124) may not include the edge management application (134). The edge management application (134) may be configured to process the UE sensor data and/or the edge sensor data to detect a change in the edge device’s (124) status and/or state, which may indicate an impairment in the edge device’s (124) connection. For example, the edge device (124) may monitor Quality of Service (QoS) data and a reduction in the QoS data may trigger the edge device (124) to execute an ATSSS procedure to route traffic accordingly.

The edge management application (134) is also configured to transmit edge state change data for the edge device (124) and/or the UE (106) state change data to the core management application (126) in the core network (101). The edge state change data for the edge device may, for example, include status change data, a location of the edge device (124), signal strength, and/or logged event data. The various devices with roles in a given implementation may coordinate to resolve network issues, may work independently, or may be managed in some other way (e.g., core, distributed, hierarchical, etc.).

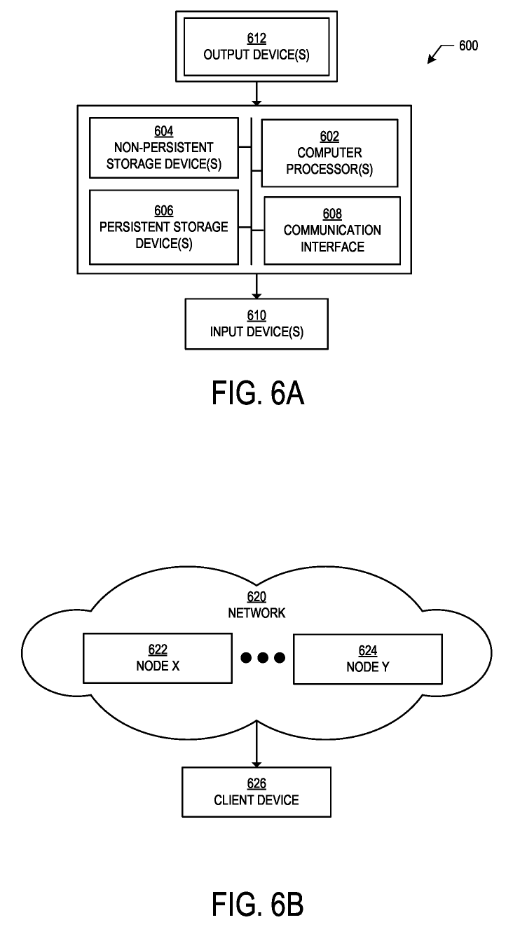

The system (100) also includes the environmental module (116). The environmental module (116) is software or application specific hardware which, when executed by a computer processor such as the computer processor (602) (shown and described in FIG. 6A), is configured to process environmental sensor data from environmental sensor(s) (118) to, for example, determine environmental data. The environmental sensor(s) (118) can include any number of environmental sensors such as one environmental sensor, two environmental sensors, or more than two environmental sensors. In embodiments where the environmental sensors (118) include multiple sensors, a first sensor can be used to reconfigure connections to other sensors to functionally extend the first sensor.

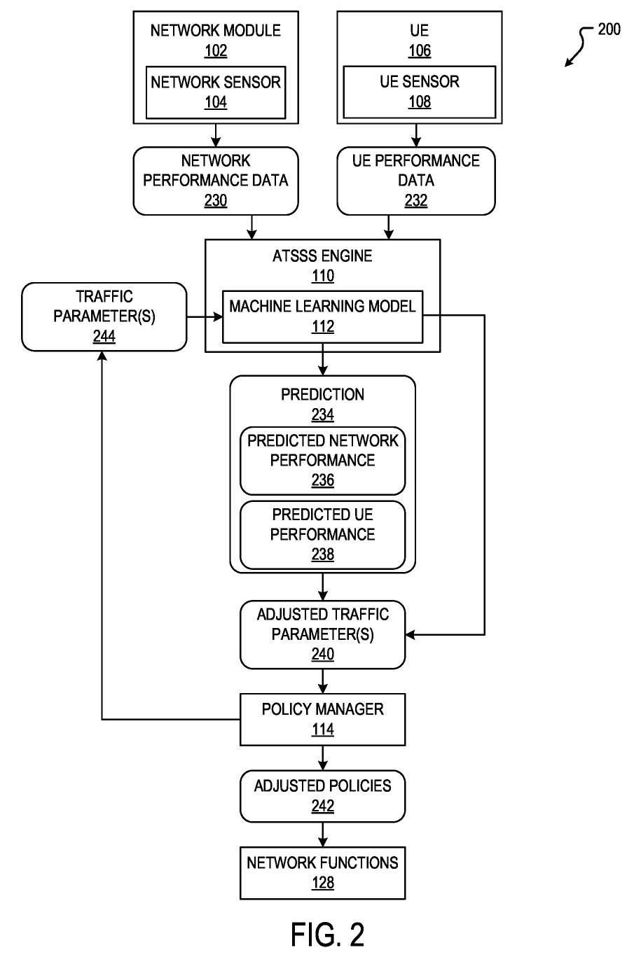

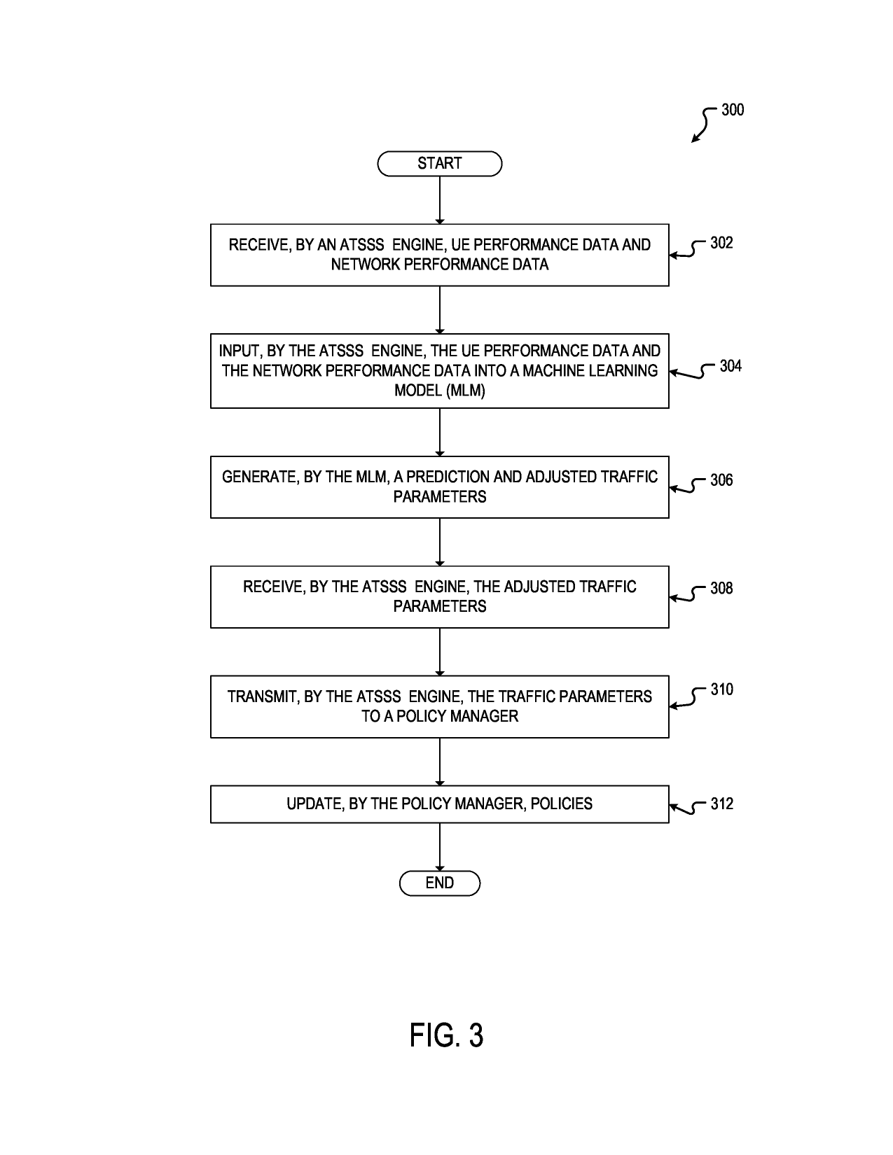

The environmental data can include, for example, temperature, location, humidity, altitude, elevation, weather conditions, etc. The environmental data can be optionally used to, for example, predict future or anticipated network performance and/or demands, as described in more detail in FIG. 2 and FIG. 3.

Returning to the core network (101), the core network (101) includes a network module (102). The network module (102) is software or application specific hardware which, when executed by a computer processor such as a computer processor (602) (shown and described in FIG. 6A), is configured to process network sensor data from network sensor(s) (104) to, for example, determine network performance data that correlates to network performance of the telecommunication network. The network performance data can include, for example, network traffic patterns, current network loads, traffic congestion levels, UE device usage, latency, jitter, packet loss, signal quality (Received Signal Strength Indicator (RSSI), Signal-to-Interference-plus-Noise Ratio (SINR), Reference Signal Received Power (RSRP), etc.), application types, and/or bandwidth requirements. The network performance data can be used to, for example, predict future or anticipated network performance and/or demands, as described in more detail in FIG. 2 and FIG. 3.

The network sensor(s) (104) are configured to sense, collect, and/or measure sensor data correlating to network data such as, for example, locations of devices in the network, signal data, protocol type and/or classification data, configuration data, scheduler data, device telemetry, etc. The network sensors (104) can include any number of network sensors such as one network sensor, two network sensors, or more than two network sensors.

In some embodiments, the network sensors (104) may be implemented as a software‑defined or virtualized interface that is designated as an authorized data source associated with a network device, connected machine, or software agent. Such a software‑defined network sensor (104) may access information through one or more interfaces, protocols, or control mechanisms and provide sensor data in a manner functionally equivalent to a physical sensor. The characteristics, functions, or role of the software‑defined sensor may be defined dynamically based on system requirements or a requested operational role. Creation of the virtual sensor may be negotiated among system components or automatically instantiated by a system, controller, or software agent.

The core network (101) also includes an ATSSS engine (110). The ATSSS engine (110) is software or application specific hardware which, when executed by a computer processor such as the computer processor (602), is configured to receive the network performance data from the network module (102), the UE performance data from the UE (106), and/or the environmental data from the environmental module (116). The ATSSS engine (110) is also configured to input the data into the MLM (112) and transmit outputs from the MLM (112) to a policy manager (114).

The ATSSS engine (110) includes the MLM (112). In some embodiments, the MLM (112) can include more than one MLM and can include one MLM, two MLMs, or more than two MLMs. Though shown as part of the ATSSS engine (110), the MLM (112) can be integrated with or part of the edge device (124) in other embodiments. In such embodiments, the MLM (112) may be used to perform dynamic ATSSS at the edge device (124).

The MLM (112) is configured to process data in real-time from the network module (102), the UE (106), the environmental module (116), the edge device (124), or any other component(s) in the system (100) to make predictions that can be used to update policies in the system (100). More specifically, the MLM (112) is configured to output a prediction having at least a predicted future network performance and/or a predicted UE performance based on at least the network performance data, the UE performance data, and/or the environmental data received as input. The MLM (112) may also receive any other input such as, for example, operator information, user input, etc. The MLM (112) then adjusts traffic parameters based on the prediction and the traffic parameters are used by the policy manager (114) to adjust existing policies. The traffic parameters include, for example, a steering parameter, a switching parameter, and a splitting parameter. The traffic parameters may be adjusted to, for example, optimize the UE’s (106) performance based on user input and/or the prediction.

In some embodiments, the MLM (112) is a reinforcement-based learning model. In other embodiments, the MLM (112) may be any type of AI model or mixed model capable of using predictive analytics to predict interference and/or future network performance. The MLM (112) also receives real-time feedback to fine-tune the MLM (112) and uses positive and/or negative reinforcement to adjust future predictions and decisions. For example, if adjusted traffic steering results in an increase in a user’s quality of experience or results in lower latency, the MLM (112) reinforces decisions that lead to the corresponding adjusted policies. In another example, if traffic switching results in poor performance, the MLM (112) re-evaluates and avoids similar decisions that resulted in the corresponding adjusted policies.

The ATSSS engine (110) can also include a core management application (126). In some embodiments, the core management application (126) is a core management agent. The core management application (126) is configured to receive edge state change data or UE state change data from the edge device (124) and/or the UE (106), respectively. The core management application (126) is also configured to execute a troubleshooting process to determine a cause of the change (corresponding to an impairment) in the UE (106) and/or the edge device (124) state (and/or status) and to generate a troubleshooting notification based on the cause. The core management application (126) may also use, for example the MLM (112) (or any AI) to execute the troubleshooting process and generate the troubleshooting notification. In some embodiments, the troubleshooting notification may include troubleshooting instructions for a user such as, for example, a network operator or field technician to perform.

The core management application (126) may also communicate with the edge device (124) to, for example, aggregate and/or process data (whether from the network module (102), the edge device (124) itself, the UE (106), and/or the environmental module (116)). The core management application (126) may also instruct the edge device (124) and/or the UE (106) to perform an ATSSS procedure to mitigate or temporarily mitigate the impairment while troubleshooting is in process. The core management application (126) or functions of the core management application (126) may be, for example, central, distributed, or hierarchal.

The core network (101) also includes the policy manager (114). The policy manager (114) is software or application specific hardware which, when executed by a computer processor such as the computer processor (602), updates one or more policies based on adjusted traffic parameters (received from, for example, the MLM (112)). The policy manager (114) is also configured to apply and/or enforce the updated policies on network functions (128), described below.

The core network (101) also includes the network functions (128). The network functions (128) are each hardware, software, firmware, or combinations thereof that perform operations, processes, or services to support communication, control, management, routing, security, or service delivery within the system (100). Though illustrated as part of the core network (101), network functions (128) may be included in other parts of the system (100) such as, for example, an access network, data network, edge devices, etc.

The network functions (128) may include, for example, session management functions, mobility management functions, user or device authentication functions, traffic routing or forwarding functions, policy enforcement or charging functions, security or firewall functions, data aggregation or analytics functions, and/or application enablement functions and can vary depending on the type of telecommunication network and/or core network (101). For example, a 5G-core network may include network functions (128) such as an Access and Mobility Management Function (AMF), a Session Management Function (SMF), a User Plane Function (UPF), an Authentication Server Function (AUSF), a Unified Data Management (UDM), a Policy Control Function (PCF), a Network Slice Selection Function (NSSF), an Application Function (AF), a Network Data Analytics Function (NWDAF), etc. In such example, the policy manager (114) may be the PCF and the NWDAF may be the network module (102).

The system (100) can include more or less components than shown. For example, the system (100) may not include the environmental module (116) and/or the edge device (124). In another example, the ATSSS engine (110) and the policy manager (114) may be integrated into a single module. Further, the system (100) may include any components for operating a telecommunication network and components such as, for example, access networks components, controllers, antennas, etc. that are not shown for clarity.

### III.Example Dataflow and Method of Dynamic ATSSS

FIG. 2 is a dataflow (200) of the dynamic ATSSS system (100) according to at least one embodiment of the present disclosure. The dataflow (200) illustrates dynamic ATSSS including adjusting traffic parameters and updating policies based on the adjusted traffic parameters to dynamically adjust the ATSSS in real-time.

As shown, the dataflow (200) begins with the network module (102) generating network performance data (230) from network sensor data received from the network sensor (104) and the UE (106) generating UE performance data (232) from UE sensor data received from the UE sensor (108). As previously described, the network performance data (230) can include, for example, network traffic patterns, current network loads, traffic congestion levels, UE device usage, latency, jitter, packet loss, signal quality, application types, and/or bandwidth requirements and the UE performance data can include, for example, location of the UE in the network, UE mobility, power usage, a battery level, UE mobility, UE usage patterns, and/or US application types.

The network performance data (230) and the UE performance data (232) are received by the ATSSS engine (110). In some embodiments, the ATSSS engine (110) may also receive other data such as, for example, environmental data from the environmental module (116). The ATSSS engine (110) then inputs the network performance data (230) and the UE performance data (232) into the MLM (112).

The MLM (112) receives the network performance data (230) and the UE performance data (232) as input and outputs adjusted traffic parameters (240). More specifically, the MLM (112) initially generates a prediction (234) that includes at least a predicted network performance (236) and a predicted UE performance (238) based on the network performance data (230) and the UE performance data (232). For example, the predicted network performance (236) may include predicted impairments or interferences in the network performance, and the predicted UE performance (238) may include a predicted increased data usage due to a predicted user behavior. For example, the predicted user behavior may correlate to the user increasing their use of streaming data, thereby indicating increased data usage.

The MLM (112) then uses the prediction (234) to adjust traffic parameters (244), received from, for example, the policy manager (114), to yield adjusted traffic parameters (240). The traffic parameters (244) can include, for example, a steering parameter, a splitting parameter, and/or a switching parameter. The traffic parameters (244) can be adjusted to, for example, accommodate predicted reduced network performance, increased predicted UE performance needs, and/or user preferences (received as, for example, user input).

For example, the steering parameter can be based on predictions such as approaching network congestion or a user moving locations, and the steering parameter can be adjusted to steer traffic to a more optimal access network (e.g., a Wi-Fi network or a 5G network). In another example, the switching parameter can be adjusted to preemptively switch traffic from one network to another network (e.g., switching from Wi-Fi to 5G before Wi-Fi signal degrades). In still another example, the splitting parameter can be adjusted to split traffic across multiple networks based on network performance data such as real-time data on available bandwidth and latency requirements.

In another example, the traffic parameters (244) can be adjusted to coordinate control between network infrastructure and user entities to manage network utilization and enforce service level agreements. In some cases, traffic associated with one or more users, applications, or flows may be reduced, deferred, or deprioritized to enable improved performance for another user, application, or flow with higher performance requirements.

As shown, after the adjusted traffic parameters (240) are generated by the MLM (112), the policy manager (114) receives the adjusted traffic parameters (240). The policy manager (114) then adjusts existing policies to yield adjusted policies (242) based on the adjusted traffic parameters (240). The adjusted policies (242) are then applied to the various network functions (128) to implement the adjusted traffic parameters (240).

It will be appreciated that the dataflow (200) can be repeated continuously, at any time increment, or based on an event trigger such as a change in network performance and/or UE performance. Thus, as the dataflow (200) is repeated, the policies can be continuously updated and adjusted based on changing network performance data (230) and/or UE performance data (232), thereby providing a dynamic and real-time ATSSS system.

FIG. 3 is a flowchart of a method (300) according to at least one embodiment of the present disclosure. The method (300) is for dynamic ATSSS in a telecommunication network. The method (300) can be performed using, for example, a dynamic ATSSS system such as the dynamic ATSSS system (100) and can implement a dataflow such as, for example, the dataflow (200).

Step 302 of the method (300) provides for receiving, by an ATSSS engine, UE performance data and network performance data. The ATSSS engine may be the same as or similar to the ATSSS engine (110), the UE performance data may be the same as or similar to the UE performance data (232) and the network performance data may be the same as or similar to the network performance data (230).

As previously described, the ATSSS engine may receive the UE performance data from a UE such as the UE (106) and the network performance data from a network module such as the network module (102). The ATSSS engine may receive the UE performance data and the network performance data in real-time. The ATSSS engine may also receive other data such as, for example, environmental data received from an environmental module such as the environmental module (116), network operational data, and/or user input received from, for example, a user interface such as the user interface (122) of the UE.

Step 304 of the method (300) provides for inputting, by the ATSSS engine, the UE performance data and the network performance data into a machine learning model (MLM). The MLM may be the same as or similar to the MLM (112). As previously described, the MLM is configured to generate real-time ATSSS decisions based on data from the telecommunication network (e.g., network performance data), user devices such as UEs (e.g., UE performance data), and/oe external sources (e.g., environmental data). The MLM can also continuously train itself on historical data to improve future ATSSS decisions and can use supervised, unsupervised, or reinforcement learning models to generate optimal traffic steering, switching, and splitting decisions.

Step 306 of the method (300) provides for generating, by the MLM, a prediction and adjusted traffic parameter(s). The MLM is configured to generate the prediction such as the prediction (234) having at least a predicted network performance such as the predicted network performance (236) and/or a predicted UE performance such as the predicted UE performance (238). The predicted network performance may be based on the network performance data and/or environmental data, and the predicted UE performance may be based on the UE performance data and/or user input.

The adjusted traffic parameters may the be same as or similar to the adjusted traffic parameters (242) and are generated by the MLM using traffic parameters such as the traffic parameters (244) received from a policy manager such as the policy manager (114). More specifically, the MLM adjusts the traffic parameters based on the predictions to yield the adjusted traffic parameters. As previously described, the traffic parameters can include, for example, a steering parameter, a switching parameter, and/or a splitting parameter.

Step 308 of the method (300) provides for receiving, by the ATSSS engine, the adjusted traffic parameters, Step 310 of the method (300) provides for transmitting, by the ATSSS engine, the adjusted traffic parameters to the policy manager, and Step 312 of the method (300) provides for updating, by the policy manager, policies. As previously described, the policy manager is configured to update or adjust the policies based on the adjusted traffic parameters to yield adjusted policies such as the adjusted policies (242). The policy manager is also configured to implement or apply the adjusted policies to network functions such as the network functions (128), thereby enabling the dynamic ATSSS.

The method (300) described in FIG. 3 can include more or less steps. One or more steps or any combination of steps may also be repeated in the method described in FIG. 3.

### IV.Example Use cases of Dynamic ATSSS

The dynamic ATSSS system (100) as described herein can be used in many use cases in which dynamic and real-time ATSSS is beneficial. The example use cases described below are provided merely for illustrative purposes and are not limiting to the system (100). In other words, the system (100) is not limited to the example use cases provided below.

### a. Example Use Case 1

The dynamic ATSSS system (100) can enable proactive traffic management by predicting impending network conditions and user mobility to minimize service disruption. For example, a user device can initially establish a data session with a network through an Access and Mobility Management Function (AMF) and Session Management Function (SMF) of a core network (such as the core network (101)). During a session setup, an ATSSS function or engine of the system can interact with a Policy Control Function (PCF) to determine an appropriate traffic steering policy based on current network conditions and service requirements. An MLM such as the MLM (112) of the system can simultaneously receives real-time, context-aware information from a Network Data Analytics Function (NWDAF), such as signal strength, latency, and congestion levels across available access networks.

As the session progresses, the MLM can continuously analyze real-time and historical network performance data for both Wi-Fi and 5G access networks. Based on such analysis, the MLM can predict an increased likelihood of network congestion in the near future and update the PCF with revised steering policies, which are then enforced through the SMF and a User Plane Function (UPF). When the user begins moving toward an area where Wi-Fi conditions are expected to deteriorate, the MLM proactively detects the potential degradation and switches all traffic to the 5G access network before service quality is impacted. Such transition is made in real-time to ensure seamless connectivity and uninterrupted user experience.

Throughout the session, the ATSSS engine or function and MLM continues to monitor network conditions, traffic performance, and user mobility on an ongoing basis. If Wi-Fi performance further degrades, such as through increased latency observed by the user equipment, traffic can be preemptively routed entirely over 5G to preserve a quality of experience for the user. Conversely, if additional Wi-Fi bandwidth becomes available, the ATSSS egine may dynamically reintroduce traffic splitting to optimize resource utilization. Such continuous monitoring and adaptive control enables the system to scale and adjust traffic flows intelligently, while maintaining optimal performance as network conditions change.

### b. Example Use Case 2

In another use case, the system (100) may enable context‑aware decision‑making. For example, traffic steering, switching, and splitting decisions may take into account contextual information such as a user’s application type, geographic location, and surrounding network conditions. The ATSSS engine may dynamically adapt traffice depending on whether the user is at home, mobile, or located in a congested public environment. For instance, an MLM such as the MLM (112) may predict entry into a congested Wi‑Fi zone and preemptively steer traffic to a cellular network to ensure continuity of service and reduced performance degradation.

### c. Example Use Case 3

In another example use case, the system (100) may coordinate with configured network slices to enable slice‑aware traffic management. In such embodiments, ATSSS decisions made by an MLM such as the MLM (112) are synchronized with network slicing configurations such that critical traffic is prioritized and routed over the most reliable network paths, while non‑critical traffic may leverage best‑effort access networks. For example, within an autonomous vehicle system, safety‑critical sensor data may be steered through a 5G ultra‑reliable low‑latency communication (URLLC) slice, whereas less critical infotainment traffic may dynamically switch between Wi‑Fi and 3GPP access networks.

### d. Example Use Case 4

In another example use case, the system (100) may coordinate with Multi‑Access Edge Computing (MEC) resources to improve decision‑making through localized intelligence. For example, edge servers positioned closer to the user may assess network conditions in real time and execute fast and accurate steering, switching, or splitting decisions. For example, in a smart factory deployment, latency‑sensitive control data may consistently be routed through a local edge node over a cellular network, while video monitoring traffic dynamically switches between available Wi‑Fi and cellular connections based on current conditions.

### e. Example Use Case 5

In still other example use cases, the system (100) may enable dynamically selecting access networks based on security characteristics. In such embodiments, sensitive traffic may be steered toward networks offering stronger security such as, for example, encrypted tunnels or virtual private networks, and end‑to‑end encryption may be enforced as needed. For example, during a financial transaction, an ATSSS engine may prioritize cellular connectivity over public Wi‑Fi to ensure that sensitive data is transmitted over a more secure communication channel.

### f. Example Use Case 6

In other example use cases, the system (100) may provide users with enhanced control by allowing definition of custom network preferences based on individual requirements. In such examples, tsers may specify priorities related to cost savings, performance optimization, or battery conservation, and the dynamic ATSSS system may adapt accordingly. For instance, a traveler may configure an ATSSS engine to favor Wi‑Fi over 5G to reduce international roaming charges, while a business user may prefer 5G connectivity for higher reliability during critical voice or video calls.

### g. Example Use Case 7

In other examples, the system (100) may enhance ATSSS with, for example, proactive mobility management capabilities. Rather than reacting only to degraded network conditions, the system may predict future connectivity changes and user movement patterns, enabling proactive traffic steering decisions. For example, in a high‑speed train scenario, an ATSSS engine may predict an upcoming region of poor cellular coverage and proactively shift traffic toward available Wi‑Fi hotspots or alternative access networks before performance degradation occurs.

### h. Example Use Case 8

In some examples, the system (100) may take into account energy consumption characteristics of different access networks when steering or switching traffic. This capability is particularly beneficial for battery‑constrained devices such as IoT sensors or mobile user equipment. For example, an IoT device with limited battery capacity may have its traffic steered toward a low‑power Wi‑Fi network instead of continuously utilizing a more energy‑intensive 5G connection, thereby extending operational lifetime.

### V.Example Dataflow and Method of Detecting Impairments in an ATSSS System

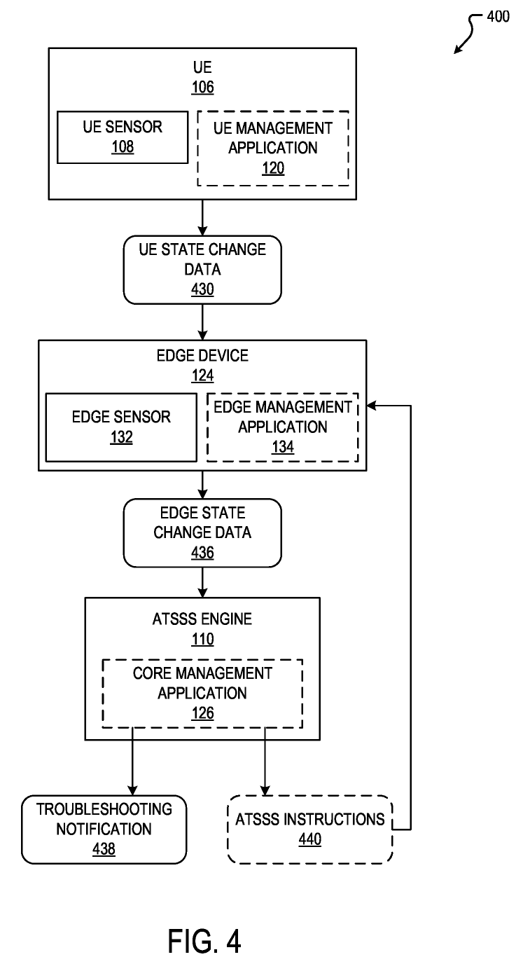

FIG. 4 is another dataflow (400) of the dynamic ATSSS system (100) according to at least one embodiment of the present disclosure. The dataflow (400) illustrates detecting impairments at a UE such as the UE (106) and/or an edge device such as the edge device (124) using the system (100).

As shown, the dataflow (400) begins with the UE management application (106) generating UE state change data (430) based on UE sensor data received from the UE sensor (108). As previously described, the UE state change data (430) can include, for example, status change data, a location of the UE (106), signal strength, and/or logged event data. The UE state change data (430) may be generated when a change in the UE state and/or status meets or exceeds a threshold. For example, the UE state change data (430) may be generated when a difference in reduced downstream data rate compared to a baseline downstream data rate exceeds a threshold, which may indicate an impairment in connectivity.

The UE state change data (430) may be received by the edge device (124) for transmittal to the core management application (126) or for further processing by the edge device (124) prior to transmittal to the core management application (126). As shown, the edge device (124) may also generate edge state change data (436) in some embodiments. Similarly to the UE state change data (430), the edge state change data (436) can be generated from edge sensor data received from the edge sensor (132). The edge sensor data may be, for example, Quality of Service data including, for example, latency, jitter, packet loss, bandwidth, connection availability and/or reliability, etc.

The dataflow (400) includes the ATSSS engine (110) receiving the UE state change data (430) and/or the edge state change data (436) and inputting the UE state change data and/or the edge state change data (436) into the core management application (126). In other embodiments, the edge device (124) may transmit the UE state change data (430) and/or the edge state change data (436) directly to the core management application (126).

The core management application (126) executes a troubleshooting process and generates a troubleshooting notification (438) based on the UE state change data (430) and/or the edge state change data (436). The troubleshooting process may determine or identify a potential impairment based on the UE state change data (430) and/or the edge state change data (436) and generate the troubleshooting notification (438) to provide information and/or instructions regarding the potential impairment. In some embodiments, the troubleshooting process may be executed at the edge device (124), distributed, or at any other network component.

The core management application (112) may also generate and transmit ATSSS instructions (440) to the edge device (124). In other embodiments, the edge device (124) itself may execute an ATSSS procedure to steer, split, and/or switch traffic. Such ATSSS procedures may be conducted, for example, in parallel with the troubleshooting process so as to temporarily mitigate or reduce network impairments until the troubleshooting process is completed. In some embodiments, the core management application (126) may use the MLM (112) to generate the troubleshooting notification (438) and/or the ATSSS instructions (440).

In some embodiments, operation of ATSSS may trigger or coordinate additional protection, projection, or restoration mechanisms at other locations within the network, including across multiple segments of one or more critical connections, in order to better satisfy specified service level agreement (SLA) requirements. For example, if activation of a backup link introduces increased latency, the ATSSS may identify and utilize a lower-latency path in another segment of the end-to-end connection to collectively meet an overall latency constraint.

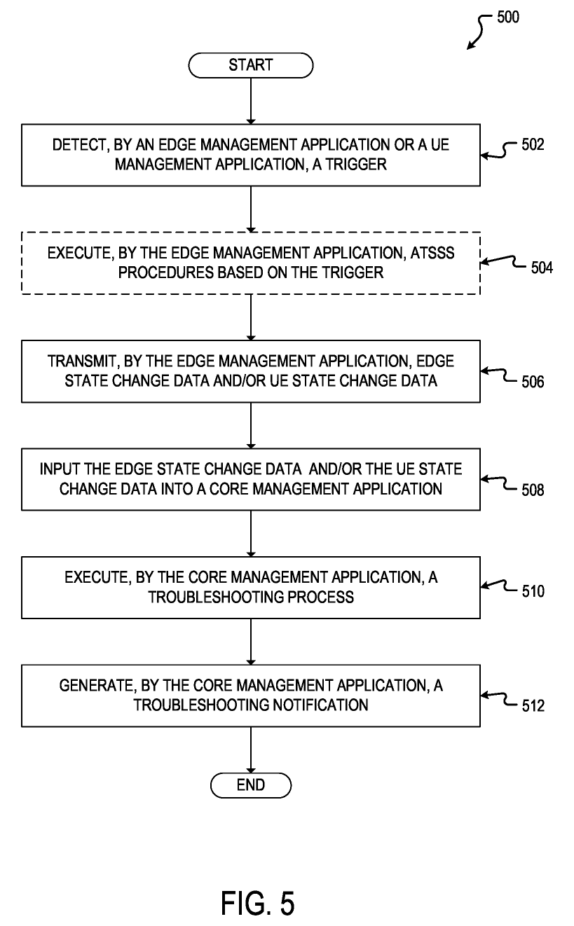

FIG. 5 is a flowchart of a method (500) according to at least one embodiment of the present disclosure. The method (500) is a method for detecting an impairment in a telecommunication network. The method (500) can be performed using, for example, a dynamic ATSSS system such as the dynamic ATSSS system (100) and can implement a dataflow such as, for example, the dataflow (400).

Step 502 of the method (500) provides for detecting, by an edge management application or a UE management application, a trigger. The edge management application may be the same as or similar to the edge management application (134) and the UE management application may be the same as or similar to the UE management application (134). The trigger may be based on a change in UE data processed from UE sensor data and/or edge data processed from edge sensor data. The trigger may correlate to a potential detected impairment due to reduced and/or deteriorating UE performance and/or edge device performance, as indicated by the UE data and/or the edge data.

Step 504 of the method (500) provides for executing, by the edge management application, ATSSS procedures based on the trigger. In some embodiments, step 504 is optional. The ATSSS procedures may be executed to mitigate and/or reduce the potential impairment detected. For example, an edge device such as the edge device (124), may execute the ATSSS procedures to switch services from a first network to a second network if the trigger indicates that the impairment may be in the first network. In some embodiments, the edge device (124) may be instructed by, for example, a core management application such as the core management application (126) to perform the ATSSS procedures.

Step 506 of the method (500) provides for transmitting, by the edge management application, the edge state change data and/or the UE state change data. The edge state change data and/or the UE state change data may be transmitted directly to the core management application or to an ATSSS engine such as the ATSSS engine (110), which may transmit the data into the core management application.

Step 508 of the method (500) provides for inputting the edge state change data and/or the UE state change data into the core management application, step 510 of the method (500) provides for executing, by the core management application, a troubleshooting process, and step 512 of the method (500) provides for generating, by the core management application, a troubleshooting notification. The troubleshooting notification may be the same as or similar to the troubleshooting notification (438).

More specifically, the core management application executes the troubleshooting procedure to determine or identify a potential impairment based on the UE state change data and/or the edge state change data and outputs a troubleshooting notification. As previously described, the troubleshooting notification may include troubleshooting instructions for a user to perform to diagnose the potential impairment. Optionally, the core management application may generate ATSSS instructions such as the ATSSS instructions (440) to instruct the edge device to execute an ATSSS procedure to steer, split, and/or switch traffic to temporarily reduce or mitigate the potential impairment.

The method (500) described in FIG. 5 can include more or less steps. One or more steps or any combination of steps may also be repeated in the method described in FIG. 5.

### VI.Example Use Cases of Detecting Impairments in a Dynamic ATSSS System

The dynamic ATSSS system (100) as described herein can be used in many use cases in which detecting connection or network impairments is beneficial. The example use cases described below are provided merely for illustrative purposes and are not limiting to the system (100). In other words, the system (100) is not limited to the example use cases provided below.

### a. Example Use Case 1

In one example, use case, when a user arrives home, an application (e.g., a UE management application) on the user device may attempt to transition connectivity from a cellular network to a local Wi‑Fi/ Data Over Cable Service Interface Specification (DOCSIS) network. The application may detect insufficient WAN performance relative to an established WAN performance baseline and, via coordination with an edge device, may transmit a detailed state report to a core management application or agent. The core management application can initiate troubleshooting actions, which may include performance correlation, remote resets, dispatching field support, etc.

### b. Example Use Case 2

In another example use case, a disruption or degradation event may occur on a DOCSIS WAN connection. An application (e.g., a UE management application, an edge management application, and/or a core management application) detects a reduced WAN performance compared to expected WAN performance benchmarks and dynamically manages traffic accordingly. The application may use, for example, an edge device and cellular connectivity to report a UE and/or edge device connection state and performance metrics to a core management application and trigger centralized diagnostics and troubleshooting procedures.

### c. Example Use Case 3

In another example use case, a performance issue or disconnection may occur on a local Wi‑Fi (LAN) network. An application (e.g., a UE management application, an edge management application, and/or a core management application) may detect degraded Wi‑Fi conditions relative to predetermined Wi-Fi baselines and may adjust traffic steering behavior. In such example, an edge device may gather relevant state and performance data and transmit such data to a core management application, where automated or assisted troubleshooting processes are initiated.

### d. Example Use Case 4

In still other example use cases, a degradation or loss of a cellular (4G/5G) connectivity may affect an edge device. An application (e.g., a UE management application, an edge management application, and/or a core management application) may detect decreased cellular performance while a Wi‑Fi and DOCSIS connectivity remains available. The application may compare network conditions against expected network condition benchmarks to detect such decreased cellular performance. The edge device may report cellular, Wi‑Fi, WAN, and location metrics to a core management application, which may then begin troubleshooting and remediation activities.

### e. Example Use Case 5

In another example use case, service quality may be continuously monitored by both an edge management application and core management agent for congestion on the DOCSIS network. Upon detecting degradation in network performance correlating to the congestion relative to expected network performance, traffic steering may be initiated either by the edge management application or by the core management agent and selected or all services may be shifted to a wireless link and reoptimized. Network performance data may be shared with DOCSIS management systems to diagnose root causes and determine whether corrective actions, such as maintenance or configuration changes, are beneficial. The edge management application and the core management agent may continue monitoring the service quality to determine whether services should remain adjusted or be restored once conditions improve.

### f. Example Use Case 6

In another example use case, an edge management application may detect a loss of WAN connectivity, which may correspond to a DOCSIS connection failure. The edge management application may then trigger a full or prioritized service transition to the wireless network and a core application agent may analyze collected state and performance data to distinguish between network outages, power disruptions, or customer‑initiated actions. Management systems may query a DOCSIS infrastructure and correlate data across multiple subscribers to assess a scope of the connection failure. The core application agent may execute troubleshooting actions and may generate troubleshooting notifications. The services may be continuously monitored to determine when restoration or further optimization is appropriate.

### g. Example Use Case 7

In still another example use case, an edge management application may shift services to a wired network based on priority and availability when a wireless (e.g., 5G) connection fails while DOCSIS remains operational. The edge management application (or any other application) may detect the wireless outage and provide network performance data to a core management application or agent. The core management application or agent may evaluate whether the issue is caused by network failure, device malfunction, or localized conditions and may correlate reports across multiple users. Following remediation of the wireless network, the edge management application may monitor feedback to determine whether traffic should be rebalanced or restored to a dual‑connectivity configuration.

### VII.Dynamic ATSSS System Benefits

The dynamic ATSSS systems and methods described herein provide many benefits. For example, integrating AI into ATSSS enables predictive and context‑aware traffic management that proactively adapts to changing network conditions, user behavior, and mobility patterns rather than reacting after degradation occurs. This predictive capability supports seamless mobility and improves a user’s quality of experience on a UE by minimizing disruptions, reducing latency, and maintaining optimal throughput as users move across environments. By continuously analyzing real‑time conditions, AI‑driven ATSSS dynamically balances traffic across wired and wireless access networks, improving overall resource utilization and avoiding congestion.

In addition, the use of management applications on end devices, edge devices, and/or core networks enhance visibility into network conditions by reporting state changes, network performance data, and location information to the core network. Such network telemetry enables proactive and remote troubleshooting of connectivity issues or impairments in the system. For example, by identifying when expected load‑sharing behavior is not occurring, issues in specific access networks may be detected and isolated. Leveraging operational links, the system can further assist in diagnosing failures such as, for example, distinguishing between congestion, hard failures, or power outages without immediate physical intervention. Further, traffic can be temporarily split, steered, or switched until the network impairment is resolved. Together, such capabilities enable the network to be more adaptive, intelligent, user‑centric, and operationally efficient for advanced traffic management.

### VIII.Example Computer and Network System for Implementation

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 6A, the computing system (600) may include one or more computer processor(s) (602), non-persistent storage device(s) (604), persistent storage device(s) (606), a communication interface (608) (e.g., Bluetooth interface, infrared interface, network interface, optical interface, etc.), and numerous other elements and functionalities that implement the features and elements of the disclosure. The computer processor(s) (602) may be an integrated circuit for processing instructions. The computer processor(s) (602) may be one or more cores, or micro-cores, of a processor. The computer processor(s) (602) includes one or more processors. The computer processor(s) (602) may include a central processing unit (CPU), a graphics processing unit (GPU), a tensor processing unit (TPU), combinations thereof, etc.

The input device(s) (610) may include a touchscreen, keyboard, mouse, microphone, touchpad, electronic pen, or any other type of input device. The input device(s) (610) may receive inputs from a user that are responsive to data and messages presented by the output device(s) (612). The inputs may include text input, audio input, video input, etc., which may be processed and transmitted by the computing system (600) in accordance with one or more embodiments. The communication interface (608) may include an integrated circuit for connecting the computing system (600) to a network (not shown) (e.g., a local area network (LAN), a wide area network (WAN) such as the Internet, mobile network, or any other type of network) or to another device, such as another computing device, and combinations thereof.

Further, the output device(s) (612) may include a display device, a printer, external storage, or any other output device. One or more of the output device(s) (612) may be the same or different from the input device(s) (610). The input device(s) (610) and output device(s) (612) may be locally or remotely connected to the computer processor(s) (602). Many different types of computing systems exist, and the aforementioned input device(s) (610) and output device(s) (612) may take other forms. The output device(s) (612) may display data and messages that are transmitted and received by the computing system (600). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (602), is configured to perform one or more embodiments, which may include transmitting, receiving, presenting, and displaying data and messages described in the other figures of the disclosure.

The computing system (600) in FIG. 6A may be connected to, or be a part of, a network. For example, as shown in FIG. 6B, the network (620) may include multiple nodes (e.g., node X (622) and node Y (624), as well as extant intervening nodes between node X (622) and node Y (624)). Each node may correspond to a computing system, such as the computing system shown in FIG. 6A, or a group of nodes combined may correspond to the computing system shown in FIG. 6A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (600) may be located at a remote location and connected to the other elements over a network.

The nodes (e.g., node X (622) and node Y (624)) in the network (620) may be configured to provide services for a client device (626). The services may include receiving requests and transmitting responses to the client device (626). For example, the nodes may be part of a cloud computing system. The client device (626) may be a computing system, such as the computing system shown in FIG. 6A. Further, the client device (626) may include or perform all or a portion of one or more embodiments.

The computing system of FIG. 6A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, i.e., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method of dynamic and real-time access traffic steering, switching, and splitting (ATSSS) for a telecommunication network, the method comprising:
receiving, by an ATSSS engine of the telecommunication network:
user equipment (UE) performance data from a UE,
network performance data from a network module;
inputting, by the ATSSS engine, the UE performance data and the network performance data into a machine learning model (MLM), the MLM configured to:
generate a prediction comprising a predicted network performance and a predicted UE performance based on the UE performance data and the network performance data;
generate an adjustment to at least one traffic parameter based on the prediction to yield at least one adjusted traffic parameter;
receiving, by the ATSSS engine, the at least one adjusted traffic parameter as output from the MLM; and
transmitting, by the ATSSS engine, the at least one adjusted traffic parameter to a policy manager configured to update one or more policies based on the at least one adjusted traffic parameter to yield one or more updated policies.

2. The method of claim 1, wherein the at least one traffic parameter comprising a steering parameter, a switching parameter, and a splitting parameter.

3. The method of claim 1, wherein the policy manager is further configured to apply the one or more updated policies to one or more network functions.

4. The method of claim 3, wherein the one or more network functions comprises an access and mobility management function (AMF) and a session management function (SMF).

5. The method of claim 1, wherein the ATSSS engine further receives user input data from a user interface and environmental data from an environmental module, and wherein the prediction is further based on the user input data and the environmental data.

6. The method of claim 1, wherein the adjusting is configured to optimize the UE performance data.

7. The method of claim 1, wherein the MLM uses reinforcement learning (RL) and is trained using historical data as training data.

8. The method of claim 1, wherein the MLM is fined-tuned using real-time data.

9. The method of claim 1, wherein the network performance data is generated from network sensor data received and processed by the network module from a network sensor.

10. The method of claim 1, wherein the UE performance data is generated from UE sensor data received from a UE sensor.

11. The method of claim 10, wherein the UE sensor data is processed by at least one of a UE management application of the UE to yield UE state change data, and wherein the UE management application transmits the UE state change data to a core management application when a change in a UE state is detected.

12. The method of claim 11, wherein the core management application receives the UE state change data, executes a troubleshooting process to determine a potential impairment based on the UE state change data, and outputs at least one troubleshooting notification.

13. The method of claim 12, wherein the troubleshooting notification includes at least one troubleshooting instruction.

14. The method of claim 13, wherein the troubleshooting process is executed by the MLM.

15. A method of detecting an impairment in an access traffic steering, switching, and splitting (ATSSS)-enabled telecommunication network, the method comprising:
receiving, by an ATSSS engine of the telecommunication network, user equipment (UE) state change data from a UE management application, the UE state change data generated from the UE management application processing UE sensor data received from a UE sensor; and
inputting, by the ATSSS engine, the UE state change data into a core management application, the core management application configured to:
execute a troubleshooting process to determine a potential impairment based on the UE state change data, and
generate a troubleshooting notification based on the potential impairment.

16. The method of claim 15, further comprising:
detecting, by an edge management application of an edge device, a trigger in network edge performance data from an edge sensor;
executing, by the edge management application, one or more ATSSS procedures based on the trigger;
transmitting, by the edge management application, edge state change data;
inputting, by the ATSSS engine, the edge state change data into the core management application, the core management application further configured to:
execute the troubleshooting process to determine an impairment causing the trigger, and
generate a troubleshooting notification based on the impairment.

17. The method of claim 16, wherein the ATSSS procedures are generated by the core management application.

18. The method of claim 15, wherein the UE state change data includes UE status change data.

19. The method of claim 16, wherein the edge state change data includes edge status change data.

20. A dynamic spectrum allocation system for a telecommunication network, the system comprising:
a user equipment (UE) comprising at least one UE sensor, the UE configured to generate UE performance data from UE sensor data received from the at least one UE sensor;
a network module comprising at least one network sensor, the network module configured to generate network performance data from network sensor data received from the at least one network sensor;
a machine learning model (MLM) configured to:
generate a prediction comprising a predicted future network performance and a predicted UE performance based on the UE performance data and the network performance data received as input; and
generate an adjustment to at least one traffic parameter based on the prediction to yield at least one adjusted traffic parameter, the at least one traffic parameter comprising a steering parameter, a switching parameter, and a splitting parameter; and
a policy manager configured to update one or more policies based on the at least one adjusted traffic parameter to yield one or more updated policies.
